(19) United States
(12) Patent Application Publication
(10) Pub. No.: US 2004/0005909 A1
(43) Pub. Date: Jan. 8, 2004

(54) Method for originating and terminating mobile (aka cellular) telephone calls on an analog phone line system utilizing the mobile handset as a gateway

(76) Inventors: Wymond K. Choy, Lafayette, CA (US); Yui Ming Yim, San Francisco, CA (US)

Correspondence Address: WYMOND CHOY, 3260 SWEET DRIVE, LAFAYETTE, CA, 94549, US

(21) Appl. No.: 10/189,633

(22) Filed: Jul. 8, 2002

(51) Int. Cl. H04B 1/38

(52) U.S. Cl. 455/557; 455/3.06

(57) ABSTRACT

A method for using Analog Telephone Sets on a Standard Phone Line System to access service provided over a Mobile Network. The interface comprises of the Mobile Handset as an Network Access Gateway, an Adapter to provide bi-directional communication between the Mobile Handset and the Analog Telephone Set, and AT commands over the RS232 serial port for call signaling between the Handset and the Mobile Network.

### CROSS REFERENCES TO RELATED PATENTS

Not Applicable

### STATEMENT REGARDING FEDERALLY SPONSORED RESEARCH OR DEVELOPMENT

Not applicable

### BACKGROUND OF THE INVENTION

1. Technical Field

This invention generally relates to telecommunications systems and more particularly relates to the method for originating and terminating mobile (aka cellular) telephone calls using standard analog phone sets.

2. Background Information

The telephone lines that connect together and are wired into residences and businesses as part of the telecommunications infrastructure are generally based on copper pairs, each pair consisting of two wires. These two wires, known as “tip” and “ring” (collectively, “analog pair”), are utilized for voice and data communication, and for communication between the Telephone Set and the PSTN (Public Switched Telephone Network) or POTS (Plain Old Telephone System). For the later, POTS rely on the manipulation of a low voltage electric current and audio tone recognition.

Mobile telephone networks, particularly those that utilize digital signaling, do not use a wired connection for communication between the handset and the mobile telephone network. Typically, call set-up requires the transmission of pre-defined call set up and tear down signals between the handset and the mobile telephone network over a common channel separate from that used for voice communication.

Today's technology requires physical contact with the Mobile Handset itself to send the call set up and tear down signals to make a call, i.e., a person needs to input the number string to be dialed and the call button to be depressed. There is no known method that would enable a standard analog phone line system to transmit such information to a cellular telephone network.

There is current practice for utilizing wires to connect an external headset (speaker and microphone) to the mobile handset for voice transmission, and a mechanism to provide remote on-hook, off-hook signaling only. With this method, the headset can only be used to “pick up” or “hang up” a call. Use of a standard telephone systems with analog telephone sets in place of headsets have also been tried, with the same limitations.

Thus, there is needed a method for standard analog telephone systems to access service provided over a mobile network (i.e. a Mobile Handset number), for originating and terminating mobile telephone calls.

### SUMMARY OF THE INVENTION

The present invention has been made in consideration of the above described limitations and needs. According to the present invention, there is provided a method using an Adapter to “dock” a Mobile Handset to the standard analog phone line system at home or business. Thereby converting the mobile service into another POTS line, providing as many extensions as there are telephone sets at the premise, and relieving users from the necessity to come into contact with Mobile Handsets.

According to the invention, connection to the mobile network is achieved using the mobile handset on the one side and connection to the analog phone line using a 2 wire connection on the RJ11 phone jack. The device may take on different shapes and provide other features as long as it allows for originating and terminating-mobile telephone calls using a telephone set on an analog phone line system.

According to the invention, there will be used a second interface circuit for Control Signals in addition to the Voice Signals. Bi-directional transmission of the Control Signals is accomplished using AT commands and responses over an RS232 based serial interface supporting call set up and tear down, and communication of status information between the Mobile Handset and the analog phone line system.

According to the invention, Mobile Handsets will have enhancements to meet the requirements of this interface of using AT commands and responses. Most Mobile Handsets today incorporate a built-in RS232 serial interface for SMS, data and fax applications.

### BRIEF DESCRIPTION OF THE DRAWINGS

FIG. 1 is a schematic diagram of the principals of the standard analog telephone system or POTS/PSTN.

FIG. 2 is a schematic diagram of the principals of the mobile telephone system.

FIG. 3 shows one of the current implementations of hands-free using the Voice Signals only.

FIG. 4 is a schematic diagram of a Mobile Handset with an Adapter employing the present invention.

FIG. 5 illustrates the interface Diagram for the Adapter with the Mobile Handset and Analog Phone. FIGS. 5A, 5B & 5C illustrate the call signal flows, system initialization and Mode of Operation Setting signal flows between the Mobile Handset, the Adapter and the analog telephone set according to the present invention.

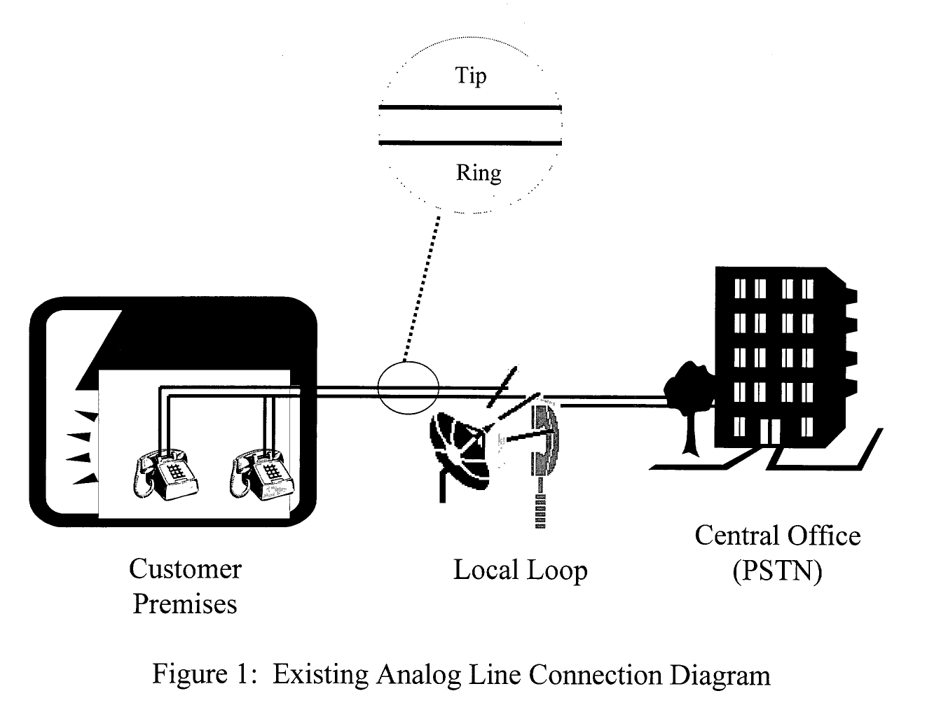

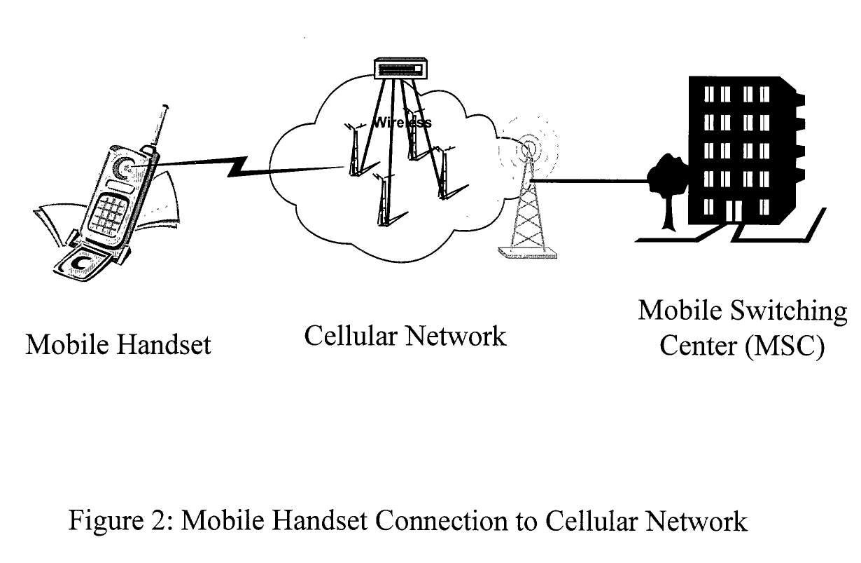

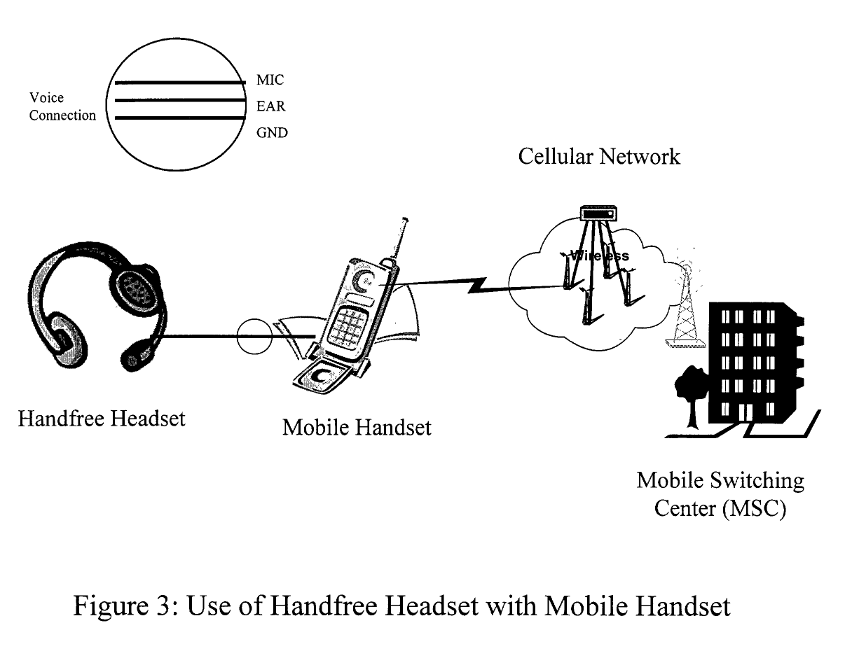

### DETAILED DESCRIPTION OF THE INVENTION

It is to be understood that the method of using Control Signals and Voice Signals to originate and terminate mobile calls is the key embodiment of this invention. The device itself may exhibit different design, form or shape. Accordingly, the description that follows is to be understood as a broad teaching disclosure directed to persons capable of designing products according to the descriptions accompanying the drawings.

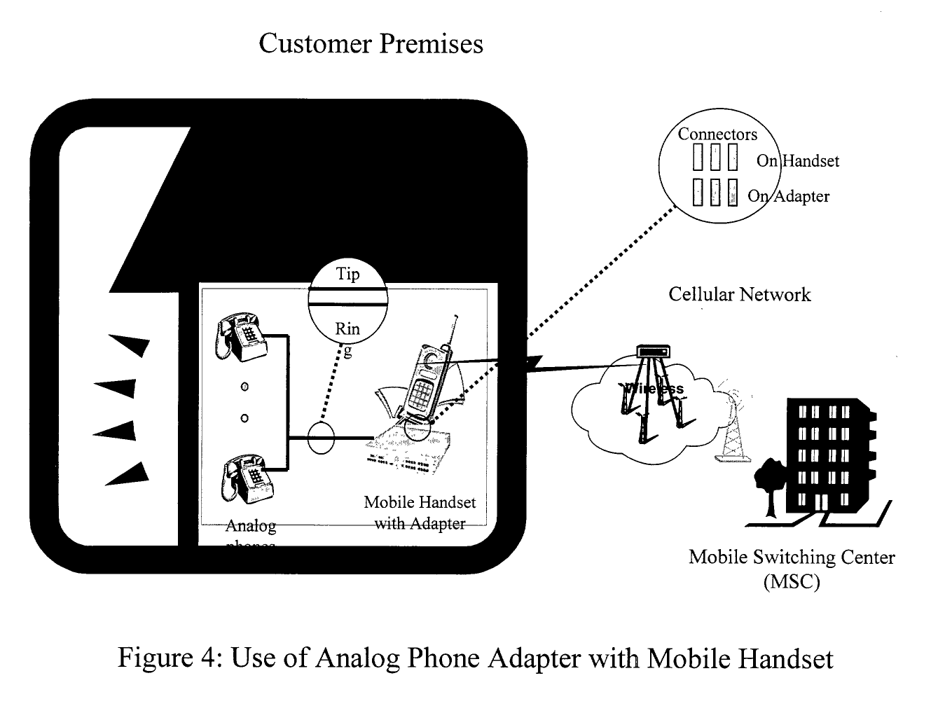

FIG. 4 shows an Adapter for a Mobile Handset and the analog phone line system according to one embodiment of the present invention. The Adapter is physically connected to the telephone line system with an RJ11 phone jack, or a 2-wire (tip and ring) connection point. The physical interface to the mobile handset in one embodiment of the invention would be a holder for the Mobile Handset with matching pins for the RS232 interface and the voice connectors.

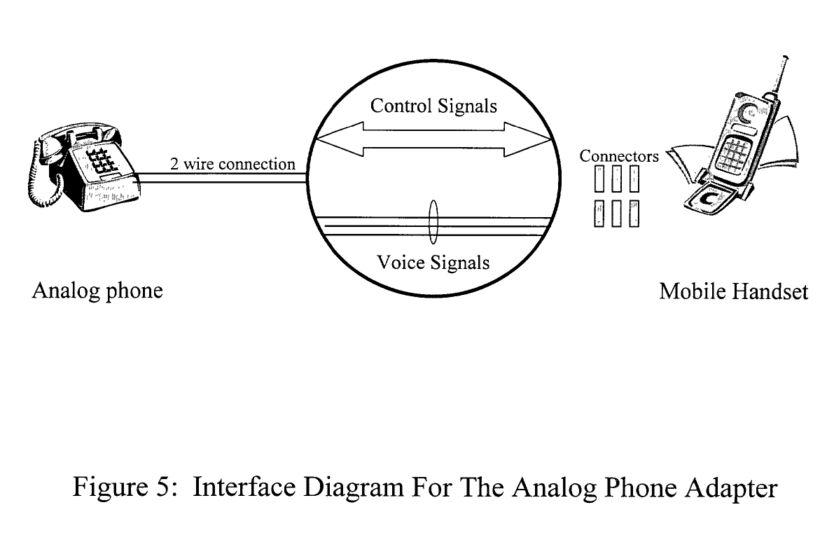

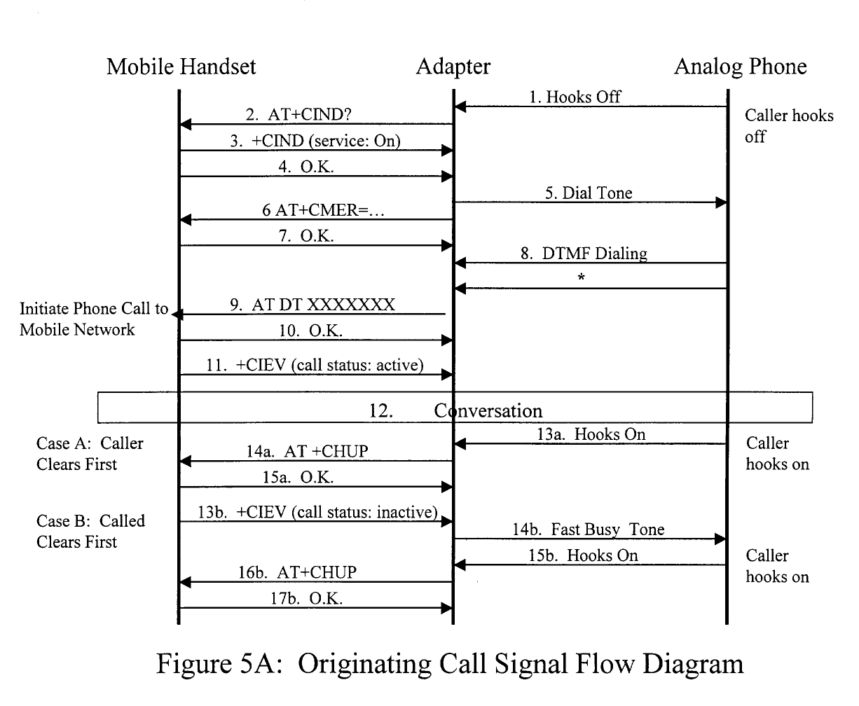

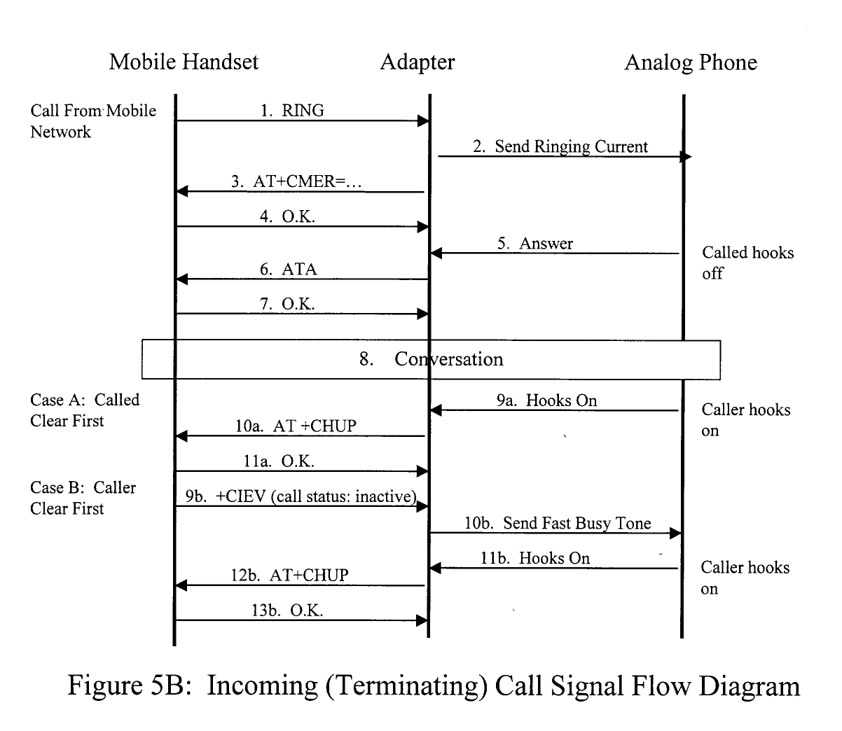

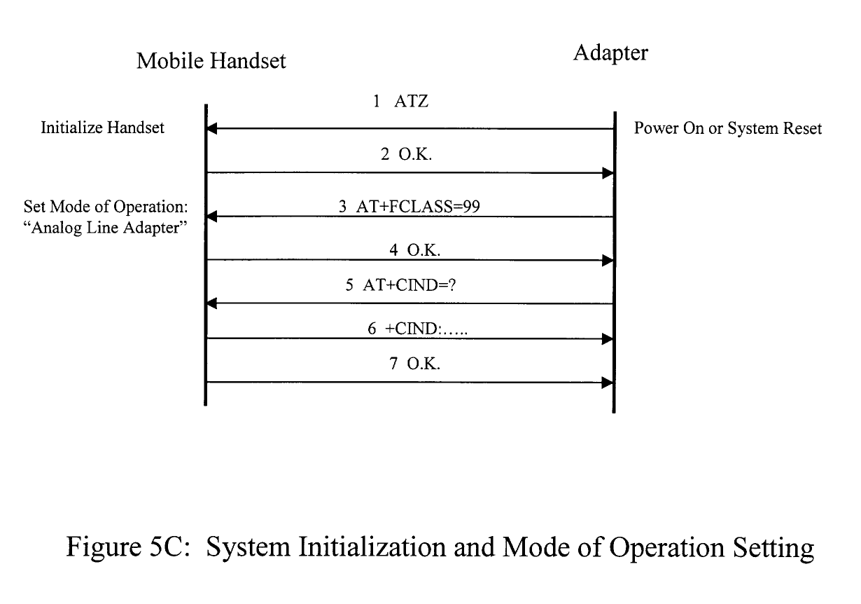

FIG. 5 depicts the main function of the Adapter, to provide a means of bi-directional communication between the analog telephone system and the Mobile Handset. In addition to bridging the voice signals, the Adapter provides the control logic and functional components to support calling in both (originating and terminating) directions. The Adapter supports the signaling, call control, generation of the call progress tones and voice path connection/disconnection. For the operations and functionalities as described in the following paragraphs, the Mobile Handset must be able to support the initialization, mode of operation, voice path connection/disconnection, signaling and call control using appropriate AT commands and responses. A new mode of operation “Analog Line Adapter” is also defined for the Mobile Handset according to this invention.

FIG. 5A is a flow chart showing diagrammatically the messages and signals exchanged between the Mobile Handset, the Adapter and the Analog Telephone Set during an originating (outgoing) call according to the present invention. Following is a step by step description of each of the signal flow, the event that triggers it, the operation in each of the entities, and the responses. The number here corresponds to the number shown in the flow diagram.

1. An off hook loop current signal is sent through the 2-wire interface to the Adapter.

2. The Adapter detects the presence of the loop current, and sends an AT+CIND? Indicator read command to the Mobile Handset. The purpose is to check if the Mobile Handset is ready to take new call.

3. On receipt of the AT+CIND? command, the Mobile Handset checks if the network is available and ready to take new call. If positive, it returns a +CIND with service ON response to the Adapter. If there exists any situation that prevents a normal phone call be initiated, a service OFF result code will be returned.

4. An O.K. response code is also returned by the Mobile Handset to the Adapter.

5. On receipt of the Service Indicator ON and O.K. responses, the Adapter generates a Dial Tone to over the tip and ring. If the response code is any thing other than this, a fast busy tone is returned.

6. The Adapter than sends an AT+CMER command to activate the indicator event reporting on the Mobile Handset.

7. The Mobile Handset acknowledges the receipt of the command.

8. DTMF tones generated by the Analog Telephone Set is collected and stored by the Adapter.

9. The numbers stored in the Adapter's memory are sent en-bloc to the Mobile Handset once the end of dialing is determined, using an AT DT command.

10. The Mobile Handset initiates a phone call to the mobile network based on the digits received and returns an O.K. response to the Adapter, signifying the successful reception of the digit sending command.

11. The Mobile Handset sends a +CIEV indicator event, reporting the progress of the call. (Call active).

12. On reception of the report, the Adapter through-connects both the Transmit and Receive sides of the voice path, allowing the passage of any audible tone and announcement from the mobile network.

Hanging up the call is accomplished by either party hanging up and the exchange of the additional messages.

Case (a): Analog Phone (Calling Party) Clears First

13a. The loop current on the tip and ring circuit is interrupted when the phone is put back on the hook.

14a. On detection of the change in current, the Adapter sends a request to the Mobile Handset to transmit a AT+CHUP hang up command to the Mobile Network.

15a. The Mobile Handset clears the connection and returns an O.K. response to the Adapter. The Adapter now returns to the idle state waiting for a new call.

Case (b): Called Party Clears First

13b. When the hang up is detected by the distant network and communicated to the Mobile Handset, the Mobile Handset sends a +CIEV indicator event report to the Adapter.

14b. The Adapter returns a fast busy tone to the caller, signifying the call is terminated.

15b. User hooks on to terminate the connection. On reception of the hook on signal from the user, the Adapter removes the fast busy tone from the circuit.

16b. The Adapter sends an AT+CHUP hang up command to the Mobile Handset.

17b. The Mobile Handset returns an O.K. response to the Adapter to complete the protocol. The Adapter now returns to idle state, ready for the next call.

FIG. 5B is a flow chart showing diagrammatically the messages and signals exchanged between the Mobile Handset, the Adapter and the Analog Telephone Set for a terminating (incoming) call according to the present invention. Following is a step by step description of each of the signal flow, the event that triggers it, the operation in each of the entities, and the responses. The number here corresponds to the number shown in the flow diagram.

1. The Mobile Handset sends a RING result code to the Adapter when it detects an incoming call from the Mobile Network.

2. The Adapter sends a ringing current over the tip and ring.

3. The Adapter sends a AT+CMER Indicator event activation command to the Mobile Handset, requesting the Mobile Handset to start reporting any change in call status.

4. The Mobile Handset returns an O.K. response code to the Adapter to advise acknowledgement of the request by the Mobile Network.

5. The user hooks off to answer the phone call. On detection of the hooks off signal, the Adapter trips the ringing current and through connects the voice path.

6. The Adapter then sends an ATA answer command to the Mobile Handset, signifying the user has answered the call.

7. On reception of the answer signal, the Mobile Handset relays the signal to the Mobile Network and through connects the call. It also returns an O.K. result code to the Adapter.

8. The caller and the called parties can proceed with their conversation over the voice path.

9-13. Hanging up the call uses the same outgoing call procedures.

FIG. 5C is a flow chart showing diagrammatically the messages and signals exchanged between the Mobile Handset and the Adapter during the Adapter's initialization and Mode of Setting Operation according to the present invention. Following is a step by step description of each of the signal flow, the event that triggers it, the operation in each of the entities, and the responses. The number here corresponds to the number shown in the flow diagram.

1. The Adapter sends an ATZ command to initialize the Mobile Handset to its Manufacturer default profile.

2. The Mobile handset acknowledges the receipt of the ATZ Initialization command by returning an O.K. response code.

3. After that, the Adapter sends an AT+FCLASS select mode command to the Mobile Handset. The Mode “99” is a new value selected for the Analogue Line Adapter.

4. On receipt of this select mode command, the Mobile Phone would change its mode of operation to Analogue Line Adapter (to distinguish it from other modes of operation like data, fax, voice etc.) The Mobile Phone will return an O.K. result after it successfully switch to the Analogue Line Adapter Mode.

5. The Adapter then sends a AT+CIND=? indicator control test command to get the order and range of Mobile Phone Indicators supported.

6. The Mobile Handset will return a list of their indicators, their range and values to the Adapter. An O.K. response code is also generated.

7. On receipt of the response, the Adapter is ready to handle both incoming and outgoing calls.

We claim:

1. Use of an Analog Telephone Set on a standard phone system to originate and terminate calls on a mobile network.

2. The use as recited in claim 1, wherein the method for originating and terminating mobile telephone calls uses the Mobile Handset as a gateway.

3. The use as recited in claim 1, wherein the method for originating and terminating a mobile telephone calls uses the Adapter as an interface between the Mobile Handset and a Standard Phone System.

4. The use as recited in claim 1, wherein the method for originating and terminating mobile telephone calls uses AT commands for call signaling on the Mobile Network.

5. The use as recited in claim 1 along with the method as recited in claim 3, wherein the Adapter may provide any other supplementary services supported by either the Mobile Handset interface or the Standard Phone System interface.
